(19) United States
(12) Patent Application Publication
(10) Pub. No.: US 2015/0077267 A1
(43) Pub. Date: Mar. 19, 2015

(54) MODULAR LIGHT SYSTEM AND RELATED METHODS

(71) Applicant: SAN DIEGO GAS & ELECTRIC COMPANY, San Diego, CA (US)

(72) Inventors: Stewart Flynn Ortiz, Carlsbad, CA (US); Sneha Parmar, San Diego, CA (US)

(73) Assignee: SAN DIEGO GAS & ELECTRIC COMPANY, San Diego, CA (US)

(21) Appl. No.: 14/488,111

(22) Filed: Sep. 16, 2014

Related U.S. Application Data
(60) Provisional application No. 61/879,560, filed on Sep. 18, 2013.

(51) Int. Cl. F21S 9/03; G01D 4/00; F21V 21/22; F21S 2/00; F21V 23/04

(52) U.S. Cl. CPC F21S 9/03; F21S 2/005; F21V 23/0464; F21V 21/22; G01D 4/002; F21W 2111/00
USPC 340/870.02; 362/183; 29/825

(57) ABSTRACT

A modular warning light system for warning aerial vehicles of an obstacle such as a steel lattice tower includes a support, a light structure adjustably mounted onto the support, a warning light coupled to the light structure, and a power system coupled to the light structure. The power system comprises a solar panel and a rechargeable battery. The solar panel is configured for charging the rechargeable battery, and the rechargeable battery is configured for powering the warning light.

### BACKGROUND

Embodiments discussed herein generally relate to aerial lighting used to provide visual warning of structures and overhead power lines, and more specifically, to a modular aerial light structure mounted on tall structures and power lines to provide warning to aircrafts.

The FFA has rules and protocols in place to provide safety for pilots and aircraft when navigating in the proximity of power company overhead power lines and facilities. One such FAA rule requires the installation of aerial warning lights to indicate overhead power lines and facilities. When light failure in the prior art warning light system is encountered, the root cause of the failure could be any one of the components in the light system at the top of the tower or at the power source located at the base of the tower. The aerial warning light could also be at an environmental zone requiring permits to enter, troubleshoot, and fix the source of the problem. Considerable time is typically needed to analyze the components to determine the source of the failure. In this way, each light failure is a unique and time consuming replacement project.

### SUMMARY

The various embodiments of a modular warning light system for aerial vehicles have several features, no single one of which is solely responsible for their desirable attributes. Without limiting the scope of the present embodiments as set forth in the claims that follow, their more prominent features now will be discussed briefly.

Aspects of the present disclosure include a modular warning light system that includes a support, a light structure adjustably mounted onto the support, a warning light coupled to the light structure, and a power system coupled to the light structure. In one example, the power system can include a solar panel and a rechargeable battery, the solar panel being configured for charging the rechargeable battery, and the rechargeable battery being configured for powering the warning light.

The support can comprise a frame coupled to a base adjustably mounted on a steel lattice tower, a transmission tower, a distribution tower, or any structure at a plurality of predefined mounting points. The base can be mounted on the structure at predefined mounting points by a U-bolt fastened to a mounting bracket.

The light structure can be adjustably mounted to the frame of the support. The solar panel can be adjustably mounted to the light structure.

The power system can further comprise a dusk to dawn light controller configured for turning on the warning light below a certain ambient brightness. The dusk to dawn light controller can be further configured for charging the rechargeable battery at a certain ambient brightness.

A remote monitoring unit can be mounted to the light structure and be configured for monitoring the power system and wirelessly transmitting telemetry data of the power system. The telemetry data can include information indicating the warning light is not functioning or the power system is not functioning.

The modular warning light system can further include a 24 hour controller configured for controlling power to the warning light, an enclosure, and a fuse assembly inside the enclosure.

The frame comprises three legs extending to the base to form a triangular pyramidal structure.

The warning light can be mounted to a member of the light structure. The light structure can be rotatably mounted to the support. The solar panel can be rotatably mounted to the light structure.

The warning light can be powered by service power and the rechargeable battery can power the warning light 40 when service power is unavailable.

The light structure can comprise a plurality of members assembled together, with each of member having an adjustable length to adjust the overall size of the light structure and the angle of the members within the light structure. For example, the light structure can comprise a central member, a first cross member crossing the central member and rotatably mounted to the frame, a second cross member crossing the central member, an angled member extending from the second cross member, an extending member extending from the second cross member, and a mounting member extending from the extending member to the angled member. The light structure can further comprise a first mounting member support coupled between the extending member and the mounting member, and a second mounting member support coupled between the mounting member and the angled member.

The solar panel can be mounted to the mounting member. The rechargeable battery can be mounted on the mounting member.

A length of the angled member can be adjustable to adjust the angle of the solar panel. For example, the angled member can comprise a second angled sub member slidably insertable inside a first angled sub member. A plurality of through holes can be defined in one of the first angled sub member and the second angled sub member. At least one through hole can be defined in the other of the first angled sub member and the second angled sub member. One or more pins or fasteners can extend through the through holes of the first angled sub member and the second angled sub member to prevent the first angled sub member and the second angled sub member from sliding apart after the length of the angled member is determined.

A length of the central member can also be adjustable. For example, the central member can comprise a second central sub member slidably insertable inside a first central sub member. A plurality of through holes can be defined in one of the first central sub member and the second central sub member. At least one through hole can be defined in the other of the first central sub member and the second central sub member. One or more pins or fastener can extend through the through holes of the first central sub member and the second central sub member to prevent the first central sub member and the second central sub member from sliding apart after the length of the central member is determined.

Another aspect of the present disclosure includes a modular warning light system that includes an adjustable frame rotatably assembled to a mount, a light assembled to the adjustable frame and configured for charging the rechargeable battery, a solar panel adjustably mounted to the adjustable frame, and a battery mounted to the adjustable frame and configured for powering the warning light.

The mount can comprise a base and a frame fixed to the base. The base can have a plurality of predefined mounting points.

A remote monitoring unit can be mounted to the light structure and configured for monitoring the power system and wirelessly transmitting telemetry data of components of the modular warning light system such as the light, the battery, and the solar panel.

The modular warning light system can further include a dusk to dawn light controller configured for turning on the light below an ambient brightness and charging the rechargeable battery at a certain ambient brightness. The modular warning light system can also include a 24 hour controller configured for controlling power to the light, and a fuse assembly inside an enclosure.

The light can be powered by service power and the battery can be configured for powering the light when service power is unavailable.

The adjustable frame can comprise a plurality of members assembled together. Some of the plurality of members can have an adjustable length to adjust the size of the light structure and angle of the members within the adjustable frame. For example, the adjustable frame can comprise a central member, a cross member crossing the central member, an angled member extending from the second cross member, an extending member extending from the second cross member, and a mounting member extending from the extending member to the angled member. A length of the central member and the angled member can be adjustable. The adjustable frame can further comprise a first mounting member support coupled between the extending member and the mounting member, and a second mounting member support coupled between the mounting member and the angled member.

The solar panel can be mounted to the mounting member. The battery and the remote monitoring unit can also be mounted on the mounting member.

In another aspect of the present disclosure, a method of repairing a warning light system can include: visiting a job site having an alert, a failure, or both in or to a warning light system mounted above the ground on a structure; removing the warning light system having the alert or the failure; and mounting a working warning light system above the ground on the structure. The working warning light system can comprise a frame mounted on a base, an aircraft warning light coupled to the frame, and a power system coupled to the frame. The power system can comprise a rechargeable battery and a solar panel. The removing step can comprise use of an aerial vehicle. The working warning light system can further comprise a remote monitoring unit. The structure can be a transmission tower or a distribution tower.

The present application is further understood to include a method of manufacturing a modular warning light system and a method of using a modular warning light system.

### BRIEF DESCRIPTION OF THE DRAWINGS

The various embodiments of the present aerial light structure are now discussed in detail and with an emphasis on highlighting the advantageous features. These embodiments depict the novel and non-obvious features of the aerial light structure shown in the accompanying drawings, which are for illustrative purposes only. These drawings include the following figures, in which like numerals indicate like parts.

FIG. 1 is an isometric view of one embodiment of a modular light system.

FIG. 2 is an isometric view of another embodiment of the modular light system.

FIG. 3 is a front view of yet another embodiment of the modular light system.

FIG. 4 is a profile view of the modular light system of FIG. 3.

FIG. 5 is a profile view of a light structure and a power system of the modular light system.

FIG. 6 is a view of a warning light and a light plate of the modular light system.

FIG. 7 is a view of the light guide plate.

FIG. 8 is a view of a U-bolt to bracket assembly.

FIG. 9 illustrates a member of the light structure and a bracket.

FIG. 10 is a view of a member sleeved inside another member and fixed together.

FIG. 11 is a schematic block diagram of the power system components.

### DETAILED DESCRIPTION

The following detailed description describes the present embodiments with reference to the drawings. In the drawings, reference numbers label elements of the present embodiments. These reference numbers are reproduced below in connection with the discussions of the corresponding drawing features.

The present system, device, and method of aerial lighting comply with the FAA required aerial lights and have easily installed and removal features. Historically, aerial light systems were connected to electrical service for its power. Such service was not immediately available from the tower itself, and in remote areas, the relative scarcity of service caused problems for powering aerial tower light systems. Thus, aspects of the present disclosure include a self-contained aerial lighting system. The lighting system includes a framed structured with lights, power, and control circuits that can be packaged at ground level as a modular system and installed on site, such as on top of a transmission or distribution tower.

In one example, the power utilized in the self-contained system includes solar cells and rechargeable battery cells. During the day, the solar cells power the system and charge the battery cells. At night, the system draws its power from the battery cells. In another example, the system is further equipped with features to enable connection to electrical service. Thus, the alternative lighting system may draw power from service power and use renewable power as backup. In another example, a lighting system is provided that uses renewable power but has an optional connection for service power in the event the renewable power source is not reliable. In some embodiments, as further discussed below, the frame of the system, device and method is of an A frame design. In other embodiments, the frame may be rectangular, or irregular, or of any design rigid enough to handle the high wind loads found at or near the tops of towers. In addition, the system, device and method will allow installation by a helicopter. A feature of this design is its relative size, weight, simple, and easy connectivity mechanisms for mounting with just about any steel lattice design. Thus, the disclosed lighting system and method can be connected to multiple tower types. The components may include various tilting and pivoting structures to permit mounting the system generally horizontally or at an angle. The fitting and pivoting structures further permit aligning the solar cells with the sun and the position of the warning light. With its modular structure, the system, device and method can be removed and replaced as a unit, making each installation and replacement a matter of standardized tasks.

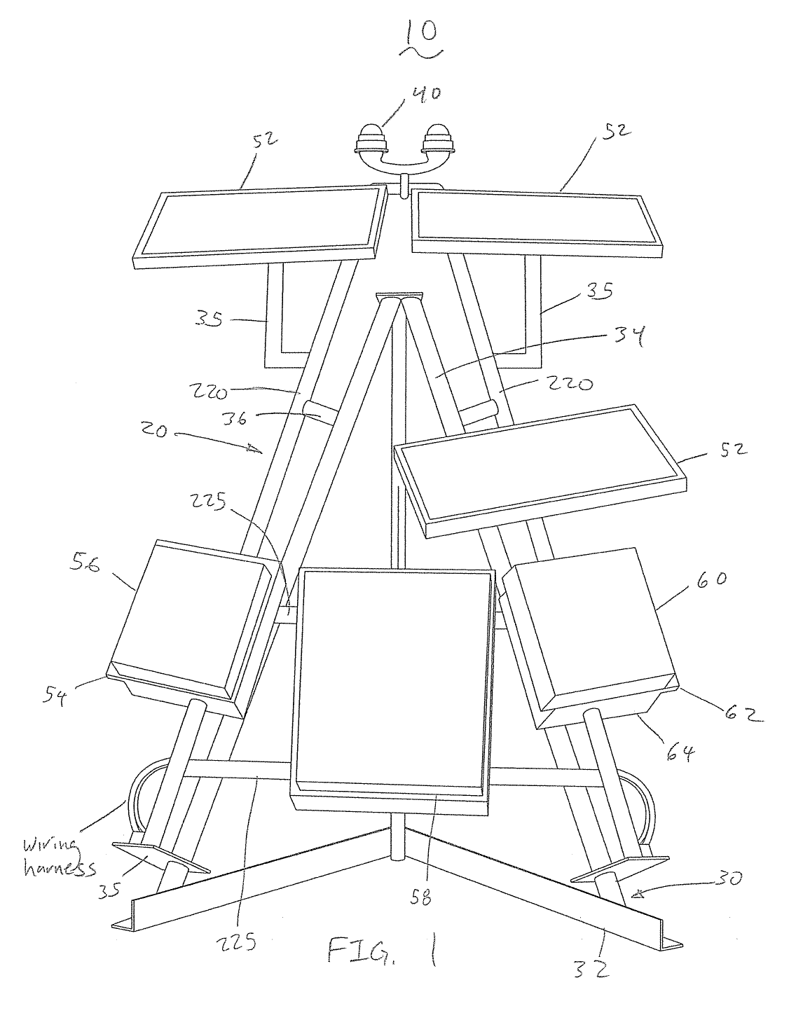

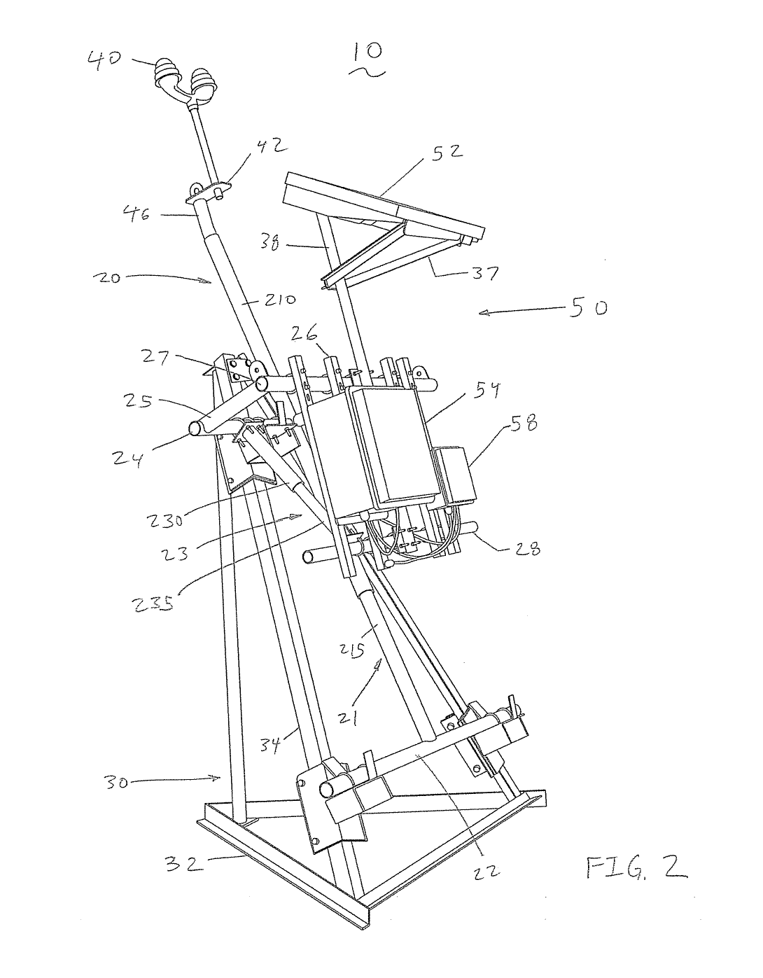

In the drawings, FIG. 1 illustrates an embodiment of a modular light system 10 in accordance with aspects of the present disclosure is illustrated. FIG. 2 illustrates another embodiment of a modular light system 10. Both embodiments will be described herein and the descriptions for each element and limitation below can be applied to either embodiment.

Referring initially to FIG. 1, the modular light system 10 in accordance with aspects of the present disclosure includes a support 30, which has a frame 34 and a base 32, a light structure 20 adjustably mounted onto the support 30, a warning light 40 coupled to the light structure 20 or the support 30, and a power system 50 for powering the warning light 40 of the light structure 20 mounted on the support 30.

The power system 50 includes one or more solar panels 52 and at least one rechargeable battery 54. The solar panel 52 is configured for charging the rechargeable battery 54. The rechargeable battery 54 is configured for powering the warning light 40. In an example, the modular light system 10 is pre-assembled and operational using the power from the power system 50 to power the warning light 40. Thus, in this example, the modular light system 10 is a single assembly unit which can be installed quickly onto a lattice tower or any other structure, and removed and replaced quickly should there be a problem or issue with the modular light system 10.

A new or replacement modular light system 10 can be replaced or installed using a helicopter, a crane, or other device and the removed modular light system 10 returned to a service center where it can be diagnosed and fixed. This eliminates the guess work that sometimes occur on the job to diagnose and repair the problem in less than ideal conditions. In other examples, peripheral devices or brackets can separately be mounted or installed on-site to the light system 10. For example, extra brackets and extra fasteners may be added at the job site as opposed to being installed in the shop along with the system.

The support 30 includes a frame 34 coupled to a base 32. The support 30 can be a rigid structure made from a high strength material configured to withstand high wind loads, such as from steel or stainless steel with rigid composite material being a workable alternative. The support 30 can be coated for rust resistance, such as painted, galvanized, or both. The support 30 can be made from a plurality of rigid sections assembled to form a fixed structure to accommodate a variety of light structures 20.

The base 32 can be adjustably mounted on a steel lattice tower or any other structure at any number of mounting points or locations. Most commonly, the system 10 is mounted at or near the top of the lattice structure so that the warning light 40 is held out to be the tallest point on the tower. Once mounted, the base 32 supports the frame 34 and the rest of the components of the light system 10. The base 32 can be mounted to any steel lattice tower at designated mounting points using a number of known prior art fastening devices, including U-bolts, clamps, metallic straps, anchoring bolts, and flanges. The number of mounting points can be one, two, three, four, or more. For example, the base 32 may be provided with a footing arrangement and the steel lattice with a corresponding footing arrangement so that when the base 32 is raised to the top of the steel lattice, the corresponding footing arrangements mate.

The base 32 can also be bolted directly to the tower. The base 32 can also be mounted to the steel lattice tower by a bracketing system. The base 32 can also be mounted to the tower using U-bolts see FIG. 8, such as a U-bolt 70 fastened to a mounting bracket 75, as previously discussed. The base 32 can be made of any material such as steel or alloys. The base 32 can be rectangular, triangular, or any shape, including irregular. For example, the base 32 can be made of L shaped channels joined together by welding or by fastening means. The base 32 should be light enough to be raised by a helicopter, a crane, or a hoist, yet strong enough to accommodate the structures and equipment.

The frame 34 is attached to the base 32 at one or more locations between the frame and the base. The frame 34 can embody a number of upstanding structures, such as being formed by a number of brackets so that the assembled frame has a certain length, width, and height. For example, the frame 34 can be shaped like a tripod having three legs mounted to a base 32 at three locations of the frame. The base 32 can have a matching footprint, such as being triangular for attaching to the base of the three legs, or a different footprint so long as means are provided to attach the frame to the base. The means can be any number of known prior art devices, including U-bolts, metal straps, fasteners, brackets, wing nuts, welding, etc. The frame 34 can be built from round tubing, rectangular tubing, bars, or any combination of materials to form a variety of upstanding structures to accommodate and support the light frame structure 20, components of the power system 50 and any peripheral device, such as an alarm or alert system for alerting a user or operator of a failure or error signal.

The light structure 20 can be a rigid structure, can be made from a high strength material configured to withstand high wind loads, such as from steel or stainless steel, or alloys, with rigid composite material being a workable alternative. The light structure 20 can also be coated for rust resistance, such as painted, galvanized, or both. The support 30 can be made from a plurality of rigid sections assembled to form a fixed structure to accommodate a variety of components. The light structure 20 can be made from round tubing, rectangular tubing, bars, I-channel (standard or wide-flange), C-channel, L-angle channel, (equal or unequal legs), structural Tee channel, or any combination of materials to form a variety of structures to accommodate and support the power system 50. The light structure 20 can be rotatably mounted or fixed directly to the frame 34 by U-bolts 70 and brackets 75 (see, e.g., FIG. 8) for example. The light structure 20 can also be adjustable in size, such as by telescoping lengths, and configuration to accommodate a variety of power systems 50. For example, the light structure 20 can be configured to allow for a variety of angles and sizes required for the power system 50.

In the embodiment of FIG. 1, the light structure 20 is an A-frame structure comprising two first members 220 and two second members 225 intersecting the two first members 220. In one embodiment, as shown in FIG. 2, the light structure 20 includes a plurality of members assembled together, each of the plurality of members having an adjustable length to adjust the size of the light structure and angle of the members within the light structure 20. For example, the light structure 20 includes a central member 21, a first cross member 22 crossing the central member 21, a second cross member 24 crossing the central member 21, an angled member 23 extending from the second cross member 24, an extending member 25 extending from the second cross member 24, and a mounting member 26 extending from the extending member 25 to the angled member 23.

The light structure 20 can further include a first mounting member support 27 coupled between the extending member and the mounting member 26, and a second mounting member support 28 coupled between the mounting member 26 and the angled member 23. The light structure 20 can be mounted to the frame 34 of the support 30 via brackets 29 and fasteners. The brackets 29 can also be used to help support the second cross member 24

The light structure 20 can be adjustably mounted to the frame 34 of the support 30. The adjustment of the light structure 20 with respect to the frame 34 can be by rotation, translation, or both. The light structure 20 can be mounted to the frame 34 using U-bolts 70 and brackets 75 (see FIGS. 8 and 9), or other fastening means.

The solar panel 52 can be mounted to the mounting member 26. The solar panel 52 can be mounted to a solar mounting bracket 37 which can facilitate adjustment of the solar panel 52 by translation and rotation to maximize the amount of light received by the solar panel 52. A length of the angled member 23 can also be adjustable to provide additional adjustment for the solar panel 52 such as an angular adjustment.

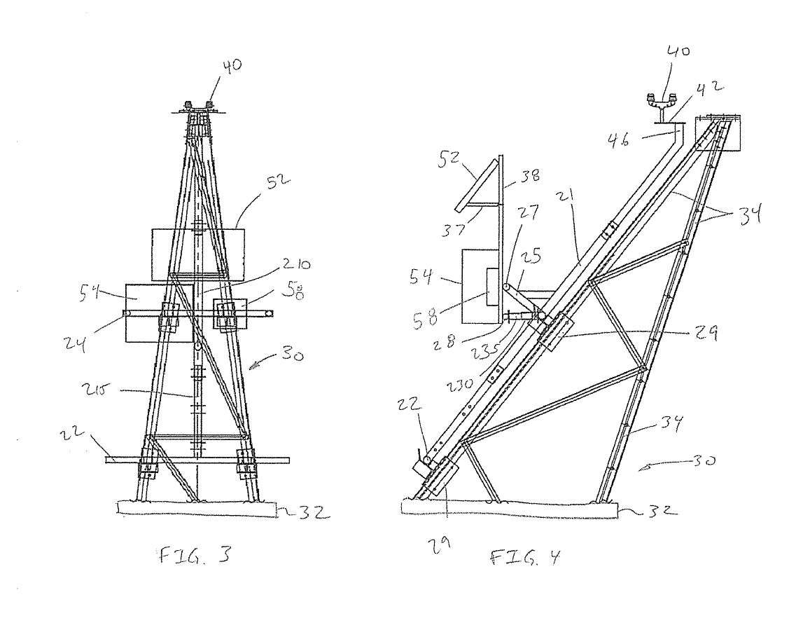

Referring to FIGS. 3-5, the angled member 23 can include a first angled sub member 230 and a second angled sub member 235 slidably insertable inside the first angled sub member 230. A plurality of through holes can be defined in either the first angled sub member 230 or the second angled sub member 235, and at least one through hole can be defined in the other of the first angled sub member 230 and the second angled sub member 235 to adjust a length of the angled member 23. A pin or fastener can extend through the through holes of the first angled sub member 230 and the second angled sub member 235 to prevent the first angled sub member 230 and the second angled sub member 235 from sliding apart after the length of the angled member 23 has been adjusted, as shown in FIG. 10.

The length of the central member 21 can also be adjustable. The central member 21 can include a first central sub member 210 and a second central sub member 215 slidably insertable inside the first central sub member 210. A plurality of through holes are defined in one of the first central sub member 210 and the second central sub member 215, and at least one through hole is defined in the other of the first central sub member 210 and the second central sub member 215. A pin or fastener can extend through the through holes of the first central sub member 210 and the second central sub member 215 to prevent the first central sub member 210 and the second central sub member 215 from sliding apart after the length of the central member 21 is determined, as shown in FIG. 10.

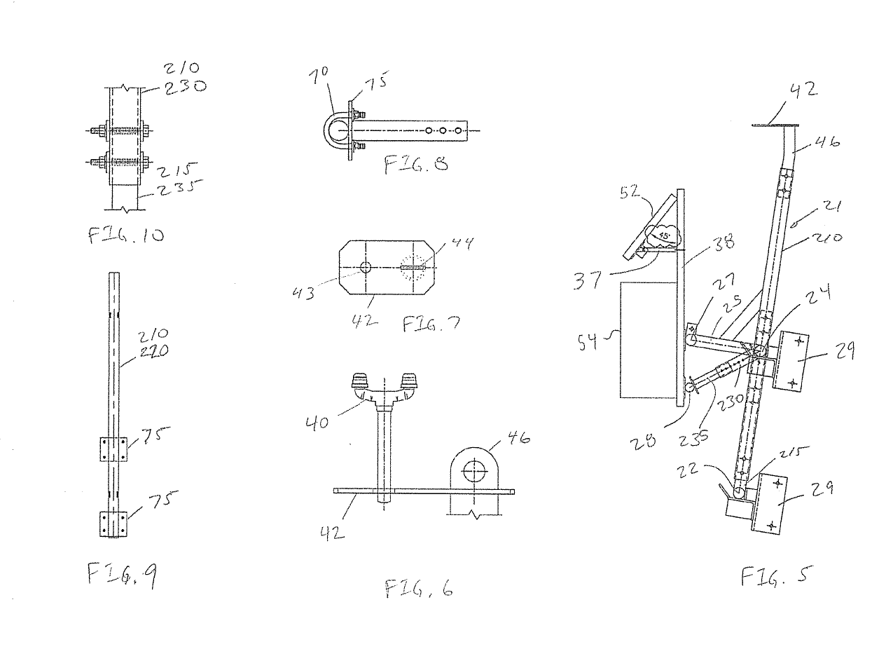

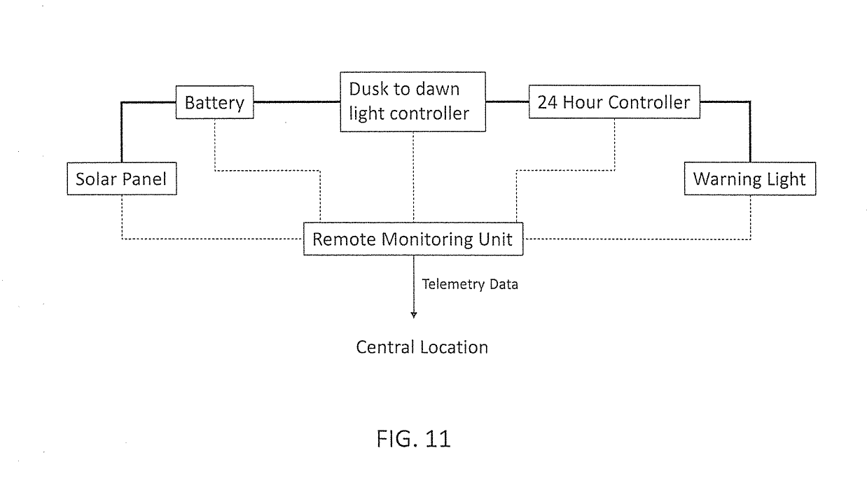

The warning light 40 is coupled to the support 30 or light structure 20 and configured for warning or alerting aircraft or other aerial vehicles of the presence of a tower, building, or other large structure. Referring to FIG. 1, the warning light can be coupled to ends of the first members 220. Referring to FIG. 2, the warning light 40 can be mounted to a central member 21 of the light structure 20 via a light plate 42 and a mounting pole 46 extending from the light structure 20, central member 21, or support 30. Referring also to FIGS. 6 and 7, the light plate 42 can be a flat plate with two holes 43, 44 defined therein for attaching to the warning light 40 and the mounting pole 46 respectively. The holes 43, 44 can be round, slotted or any other shape.

The mounting pole 46 has a first end attached to the light plate 42 and a second end attached to the central member 21 of the light structure 20. The mounting pole 46 can have an outer diameter slightly smaller than an inner diameter of the central member 21 of the light structure 20, so that the mounting pole 46 can slide into the central member 21 and fastened to the central member 21 with fasteners. In the illustrated embodiment the first end engages in the slotted hole 44 of the light plate 42.

The warning light 40 is electrically coupled to the power system 50. The warning light 40 is powered by the rechargeable battery 54. Alternatively, the warning light 40 can be powered by service power and the rechargeable batteries 54 can be configured for powering the aircraft warning light 40 when service power is unavailable, such as for backup. The warning light 40 can have one or more bulbs such as an LED, halogen, fluorescent, or incandescent, as long as the warning light is bright enough and free from obstructions. The warning light 40 can be a pair of warning lights 40 or more than two warning lights. The color of the light radiated by the warning light 40 can be any color such as blue, red, or orange. For example, the warning light can be a 12 VDC dual red LED light head.

The power system 50 includes a solar panel 52 and a rechargeable battery 54. The solar panel 52 is configured for charging the rechargeable battery 54. The solar panel 52 is adjustably mounted to the light structure 20. The solar panel 52 can also be rotatably mounted to the light structure 20. The solar panel 52 can be rotatably mounted to a solar panel mounting bracket 37. The solar panel 52 and the solar panel mounting bracket 37 can also be coupled to a solar panel post 38 coupled to the light structure 20. The solar panel 52 can include a set of photovoltaic modules coupled to an inverter, if necessary, a solar tracker, and wiring. The photovoltaic modules can include a connected assembly of solar cells. The solar panel 52 can include crystalline silicon modules or thin film modules such as rigid thin film modules and flexible thin film modules. Solar trackers increase the amount of energy produced per module by sensing the direction of the sun and tilting the modules for maximum exposure to the light. For example, the solar panel 52 can be a 50 watt solar panel 52 such as the BP® Solar BP350J. More than one solar panel 52 can be used.

The rechargeable battery 54 can be a lithium-ion battery, nickel metal hydride battery, photovoltaic battery, or any type of battery capable of storing and releasing energy from the solar panel 52. The number of rechargeable batteries 54 can be one or more, at least sufficient enough to power the warning light 40 from dusk till dawn or extended period of darkness. For example, the rechargeable battery 54 can be a 12V battery such as the Deka® Solar Voltaic 12V battery. More than one rechargeable battery 54 can also be used.

The power system 50 can further include a dusk to dawn light controller 56 configured for turning on the warning light 40 below a predetermined ambient brightness. The dusk to dawn controller 56 recognizes brightness and activates a light switch. The dusk to dawn light controller 56 is electrically coupled to the warning light 40 and the rechargeable battery 54. The dusk to dawn light controller 56 can also be configured for charging the rechargeable battery 54 at a certain ambient brightness.

The modular light system 10 can also include a remote telemetry unit (RTU) or a remote monitoring unit 58 mounted to the light structure 20 or support 30. The remote monitoring unit 58 can be configured for monitoring the power system 50 and wirelessly transmitting telemetry data of the power system 50. The telemetry data can include information such as indicating the warning light 40 is not functioning or not powered on, the power system 50 is not functioning, voltage is not discharged from the batter or batteries, voltage/current to the warning light 40 reads below a certain threshold, and the status of the charging system, etc. The telemetry can be sent to a central location receiving the data to alert and activate crews to fix or replace the modular light system 10. For example, the remote monitoring unit 58 can be the On-Ramp Wireless™ Remote Monitoring Unit.

The modular light system 10 can also include a 24 hour controller 60 configured for controlling power to the warning light 40.

The modular light system 10 can also include an enclosure 62 and a fuse assembly 64 inside the enclosure 62. The fuse assembly 64 provides protection from a surge in power or current to each or some of the components. The enclosure 62 can be made of any material such as plastic, metal, or nonmetal to protect the fuse from environmental pollutants and contaminants such as rain, dust, or debris. For example, the enclosure can be the Stahlin® environmental enclosure.

The rechargeable battery 54, the fuse assembly 64 and the enclosure 62, the 24 hour controller 60, the remote monitoring unit 58, and the dusk to dawn controller 56 can be mounted on the mounting member 26 or directly to the light structure 20. The mounting member 26 can be a planar member, one or more vertical bars, one or more horizontal bars, or any other element so long as components can be mounted.

Although limited embodiments of the modular light system 10 and their components have been specifically described and illustrated herein, many modifications and variations will be apparent to those skilled in the art. For example, the various component parts may incorporate different materials, some sub-assemblies may be unitarily formed, etc. Furthermore, it is understood and contemplated that features specifically discussed for one modular light system 10 may be adopted for inclusion with another modular light system 10 embodiment, provided the functions are compatible. Accordingly, it is to be understood that the modular light system 10 and their components constructed according to principles of the disclosed device, system, and method may be embodied other than as specifically described herein. The disclosure is also defined in the following claims.

What is claimed is:

1. A modular warning light system 10 for aerial vehicles comprising:
a support 30;
a light structure 20 adjustably mounted onto the support 30;
a warning light 40 coupled to the light structure 20; and
a power system 50 coupled to the light structure 20, the power system 50 comprising a solar panel 52 and a rechargeable battery 54, the solar panel 52 being configured for charging the rechargeable battery 54, the rechargeable battery 54 being configured for powering the warning light 40.

2. The modular warning light system 10 of claim 1, wherein the support 30 comprises a base 32 and a frame 34 coupled to the base 32, and the base 32 is adjustably mounted on a steel lattice tower at a plurality of predefined mounting points.

3. The modular warning light system 10 of claim 2, wherein the light structure 20 is adjustably mounted to the frame 34 of the support 30.

4. The modular warning light system 10 of claim 1, wherein the solar panel 52 is adjustably mounted to the light structure 20.

5. The modular warning light system 10 of claim 1, wherein the power system 50 further comprises a dusk to dawn light controller 56 configured for turning on the warning light 40 below a certain ambient brightness.

6. The modular warning light system 10 of claim 1, further comprising a remote monitoring unit 58 mounted to the light structure 20 and configured for monitoring the power system 50 and wirelessly transmitting telemetry data of the power system 50.

7. The modular warning light system 10 of claim 6, wherein the telemetry data includes information indicating the warning light 40 not functioning or the power system 50 not functioning.

8. The modular warning light system 10 of claim 1, wherein the light structure 20 comprises a plurality of members assembled together, each of the plurality of members having an adjustable length to adjust the size of the light structure and angle of the members within the light structure 20.

9. The modular warning light system 10 of claim 1, wherein the light structure 20 comprises a central member 21, a first cross member 22 crossing the central member 21 and rotatably mounted to the frame 34, a second cross member 24 crossing the central member 21, an angled member 23 extending from the second cross member 24, an extending member 25 extending from the second cross member 24, and a mounting member 26 extending from the extending member 25 to the angled member 23.

10. The modular warning light system 10 of claim 9, wherein the light structure 20 further comprises a first mounting member support 27 coupled between the extending member and the mounting member 26, and a second mounting member support 28 coupled between the mounting member 26 and the angled member 23.

11. The modular warning light system 10 of claim 9, wherein a length of the angled member 23 is adjustable to adjust the angle of the solar panel 52.

12. The modular warning light system 10 of claim 11, wherein the angled member 23 comprises a first angled sub member 230 and a second angled sub member 235 slidably insertable inside the first angled sub member 230, a plurality of through holes are defined in one of the first angled sub member 230 and the second angled sub member 235, and at least one through hole is defined in the other of the first angled sub member 230 and the second angled sub member 235, and a pin or fastener extends through the through holes of the first angled sub member 230 and the second angled sub member 235 to prevent the first angled sub member 230 and the second angled sub member 235 from sliding apart after the length of the angled member 23 is determined.

13. The modular warning light system 10 of claim 9, wherein a length of the central member 21 is adjustable.

14. The modular warning light system 10 of claim 13, wherein the central member 21 comprises a first central sub member 210 and a second central sub member 215 slidably insertable inside the first central sub member 210, a plurality of through holes are defined in one of the first central sub member 210 and the second central sub member 215, and at least one through hole is defined in the other of the first central sub member 210 and the second central sub member 215, and a pin or fastener extends through the through holes of the first central sub member 210 and the second central sub member 215 to prevent the first central sub member 210 and the second central sub member 215 from sliding apart after the length of the central member 21 is determined.

15. A modular warning light system 10 comprising:
a mount 30 comprising a frame 34 fixed to a base 32, the base 32 having a plurality of predefined mounting points;
an adjustable frame 20 rotatably assembled to the mount 30;
a light 40 assembled to the adjustable frame 20 and configured for charging the rechargeable battery 54;
a solar panel 52 adjustably mounted to the adjustable frame 20;
a battery 54 mounted to the adjustable frame and configured for powering the warning light 40; and a remote monitoring unit 58 mounted to the light structure 20 and configured for monitoring the power system 50 and wirelessly transmitting telemetry data of the light 40, battery 54, and the solar panel 52.

16. The modular warning light system 10 of claim 15, further comprising a dusk to dawn light controller 56 configured for turning on the light 40 below an ambient brightness.

17. The modular warning light system 10 of claim 15, further comprising a 24 hour controller 60 configured for controlling power to the light 40.

18. The modular warning light system 10 of claim 15, wherein the adjustable frame 20 comprises a plurality of members assembled together, some of the plurality of members having an adjustable length to adjust the size of the light structure and angle of the members within the adjustable frame 20.

19. The modular warning light system 10 of claim 18, wherein the adjustable frame 20 comprises a central member 21 and an angled member 23 coupled to the central member 21, and a mounting member 26 coupled to the angled member 23.

20. The modular warning light system 10 of claim 19, wherein a length of the angled member 23 is adjustable to adjust the angle of the solar panel 52, and a length of the central member 21 is adjustable.

21. The modular warning light system 10 of claim 27, wherein the battery 54 and the remote monitoring unit 58 is mounted on the mounting member 26.

22. A method of repairing a warning light system 10, the method comprising:
visiting a job site having an alert, a failure or both in or to a warning light system mounted above the ground on a structure;
removing the warning light system having the alert or the failure;
mounting a working warning light system above the ground on the structure; and
wherein the working warning light system 10 comprises a base 32, a frame 34 mounted on the base 20, an aircraft warning light 40 coupled to the frame 34, and a power system 50 coupled to the frame 34, the power system 50 comprising a rechargeable battery 54 and a solar panel 52.

23. The method of claim 22, wherein the removing step comprises use of an aerial vehicle.

24. The method of claim 22, wherein the working warning light system comprises a remote monitoring unit.

25. The method of claim 22, wherein the structure is a transmission tower or a distribution tower.
